(19) United States
(12) Patent Application Publication
(10) Pub. No.: US 2005/0242937 A1
(43) Pub. Date: Nov. 3, 2005

(54) Tired wheel with tire-information sending body, installation instrument and fixing instrument for tire-information sending body, and method of installing tire-information sending body

(75) Inventors: Takashi Yokoi, Tokyo (JP); Hajime Fukumori, Tokyo (JP)

Correspondence Address: OLIFF & BERRIDGE, PLC, P.O. BOX 19928, ALEXANDRIA, VA, 22320, US

(73) Assignee: BRIDGESTONE CORPORATION, TOKYO (JP)

(21) Appl. No.: 10/518,488

(22) PCT Filed: Jun. 11, 2003
(86) PCT No.: PCT/JP03/07442

§ 371 Date: Dec. 20, 2004

(30) Foreign Application Priority Data
Jun. 21, 2002 (JP) 2002-181338
Sep. 25, 2002 (JP) 2002-278717
Jan. 7, 2003 (JP) 2003-1226
Feb. 6, 2003 (JP) 2003-29164
Feb. 27, 2003 (JP) 2003-50457

(51) Int. Cl. B60C 23/00

(52) U.S. Cl. 340/447; 152/152.1; 340/572.8; 340/693.9

(57) ABSTRACT

The present invention provides a tire/wheel assembly that ensure a proper function of a tire-information transmitter even in a severe use condition, installation and fixing devices for the tire-information transmitter which has a superior workability, and a method of mounting a tire-information transmitter in a simple manner. In a tire/wheel assembly in which the tire is mounted on the wheel, a ring-shaped elastic body equipped with a tire-information transmitter is provided along a periphery of the rim base of the rim of the wheel.

### TECHNICAL FIELD

The present invention relates to a tire/wheel assembly with a tire-information transmitter, an installation device and a fixing device for a tire-information transmitter, and a method of mounting a tire-information transmitter.

### BACKGROUND ART

It is commonly conducted in recent years that a tire-information transmitter, such as a transponder as a typical example is attached on the tire to be equipped on a vehicle to provide a various kinds of information concerning the tire and data of the tire in use. The applicable scope of such tire-information transmitter now covers, of course, tires for passenger vehicles, tracks and buses, as well as tires for construction vehicles.

U.S. Pat. No. 4,911,217, for example, discloses a tire in which embedded is a tire-information transmitter consisting of a combination of a sensor and a transponder for measuring inner pressure and temperature of the tire and transmit their data. However, embedding such a tire-information transmitter in the tire will cause a problem of increasing the incidence of failures since the transmitter is exposed to a high temperature and a high pressure during a vulcanizing process in a tire manufacturing, and directly suffers a force input from a road and a heat generated by the tire itself during loaded running. Further, if the failure happens, the tire-information transmitter alone cannot be replaced as it is embedded in the tire. Instead, the entire tire has to be replaced, which causes another problem.

JP 9-136517 A discloses a method of adhering a tire-information transmitter on an inner surface of a tire via an elastic body and a method of fixing a tire-information transmitter on a rim base of a tire by means of a metal plate, a belt or the like. However, in the case of adhering the tire-information transmitter on the tire, the tire-information transmitter possibly comes off from where it is adhered due to an excessive input force which acts on a tire tread and is generated under such a severe use condition that a tire, especially the one for a construction vehicle, is run over a extremely bumping road, thereby failing to function properly. In the extreme case, the tire-information transmitter is directly affected by an input force from the outside and is possibly broken down. In the case of fixing the tire-information transmitter on a rim base, the tire and the wheel have to be assembled after the tire-information transmitter is fixed on the rim base. The space between the bead portion of the tire and the wheel is, however, so small that the tire-information transmitter, which has a certain thickness and is fixed on the rim base, may significantly diminish a workability of a tire-assembling operation. In addition to that, the bead portion may contact and damage the tire-information transmitter.

### DISCLOSURE OF THE INVENTION

It is, therefore, an object of the present invention to provide a tire/wheel assembly that ensure a proper function of a tire-information transmitter even in a severe use condition.

It is another object of the present invention to provide an installation device and a fixing device for a tire-information transmitter, which has a superior workability.

It is yet another object of the present invention to provide a method of mounting a tire-information transmitter in a simple manner.

To achieve the above-mentioned objects, a tire/wheel assembly according to the first aspect of the present invention comprises a tire, a wheel on which the tire is mounted, and a cavity portion defined by the tire and the wheel, wherein a tire-information transmitter is provided at a position spaced from both of the wheel and the tire in the cavity portion.

In the tire/wheel assembly, a ring-shaped elastic body equipped with said tire-information transmitter is preferably provided along the periphery of a rim base of a rim of said wheel.

The ring-shaped elastic body is preferably a rubber band.

Alternatively, the ring-shaped elastic body is preferably a rubber ring.

A flexible tube equipped with the tire-information transmitter is preferably provided along the inner surface of the crown portion of the tire.

A narrow hanger equipped with the tire-information transmitter is preferably sandwiched and held between a bead portion of the tire and a rim of the wheel.

It is preferred that the wheel comprises a detachable bead seat ring contacting a bead portion to form a seat face, and a narrow hanger equipped with the tire-information transmitter is fixed on the bead seat ring.

The tire-information transmitter is preferably a transponder.

An inner pressure sensor is preferably built in the tire-information transmitter.

Also, a temperature sensor is preferably built in the tire-information transmitter.

An installation device according to the second aspect of the present invention comprises a base portion to be contacted by a gutter of a wheel, the wheel comprising a rim having a detachable flange on one side and being in a state that the detachable flange has been removed, and a guide portion having an outer surface provided with a guide means, the guide means being forcedly displaced while slantly contacting a ring-shaped elastic body equipped with a tire-information transmitter to drop the elastic body on an outer periphery of a rim base of the wheel, and the base and guide portions make an L shape and the installation device moves along the gutter.

The guide means is preferably a stepped sidewall slantly extending across the outer surface of the guide portion.

A portion of the outer surface of the guide portion with which said elastic body makes contact during its movement is preferably so configured that its height at the outer surface gradually decreases along the direction in which the elastic body is dropped.

Each of the base portion and the guide portion is preferably provided with at least one rolling element at a surface to be contacted by the rim base.

The rolling element provided at the contact surface of the guide portion is preferably so configured as to be able to move along a groove formed over a whole circumference.

The installation device preferably further comprises an insert portion to be inserted from the gutter side into the inner surface side of the rim base of the wheel in a state where the detachable flange being removed, and the insert portion has an inner surface facing the inner surface of the guide portion with a given distance therebetween, and the insert portion, the base portion and the guide portion altogether form a hook-like shape.

The insert portion is preferably hinge-connected with the base portion.

The insert portion is preferably provided with at least one rolling element at a surface to be contacted by the rim base.

A fixing device according to the third aspect of the present invention comprises a base portion to be contacted by a gutter of a wheel, the wheel comprising a rim having a detachable flange on one side and being in a state that the detachable flange has been removed, a support portion extending from one end of the base portion and having a shape matched with an inner shape of the gutter, and a hold portion extending from the other end of the base portion and holding a mount provided on a ring-shaped elastic body equipped with a tire-information transmitter, and the base portion, the support portion and the hold portion altogether form a hook-like shape to be detachably fixed on the rim.

At least the support portion is preferably made of a spring steel, and the support portion, together with the base portion and/or the hold portion, is so configured as to clip the rim.

The hold portion preferably comprises a body portion extending along the outer surface of the rim base, and a clip portion branching and extending from the body portion, the clip portion being made of a spring steel, wherein the fixing device is so configured that the body and clip portions altogether clip the mount provided on the ring-shaped elastic body equipped with the tire-information transmitter.

The length of the hold portion is preferably approximately the same as the distance from the gutter to the position at which the tire-information transmitter is fixed as measured along the outer surface of the rim base.

A method of mounting a tire-information transmitter on the tire/wheel assembly according to the forth aspect of the present invention comprises; putting one bead portion of the tire onto a periphery of a rim base of the wheel; attaching a ring-shaped elastic body on the periphery of the rim base of the wheel via a space formed between the other bead portion of the tire and the wheel, the ring-shaped elastic body having been equipped with a tire-information transmitter beforehand; and fitting both of the bead portions with the rim of the wheel.

A method of mounting a ring-shaped elastic body equipped with a tire-information transmitter on a rim of a wheel by means of an installation device, the wheel comprising a rim having a detachable flange on one side, and a guide portion having an outer surface provided with a guide according to the fifth aspect of the present invention comprises; provisionally putting one bead portion of the tire from a gutter side onto a rim base of the wheel in a state that the detachable flange has been removed while a space remains between the other bead portion and the gutter of the rim; wrapping a part of the elastic body around the rim base via the space; fixing the elastic body with a fixing device; attaching a installation device to the gutter; setting the elastic body to the installation device; displacing the installation device along the gutter while elastically stretching the elastic body to mount the entire elastic body on the rim base; removing the fixing and installation devices; putting the other bead of the tire onto the rim base; and attaching the removed detachable flange to the gutter to fabricate a tire/wheel assembly.

The installation device preferably comprises a base portion to be contacted by a gutter of a wheel, the wheel comprising a rim having a detachable flange on one side and being in a state that the detachable flange has been removed, and a guide portion having an outer surface provided with a guide means, the guide means being forcedly displaced while slantly contacting a ring-shaped elastic body equipped with a tire-information transmitter to drop the elastic body on an outer periphery of a rim base of the wheel, and the base and guide portions make an L-shape and the installation device moves along the gutter. Alternatively, the installation device preferably comprises an insert portion to be inserted from the gutter side into the inner surface side of the rim base, a guide portion having an inner surface facing the inner surface of the guide portion with a given distance therebetween and an outer surface provided with a guide means, the guide means being forcedly displaced while slantly contacting a ring-shaped elastic body equipped with a tire-information transmitter to drop the elastic body on an outer periphery of a rim base of the wheel, and a base portion connecting the insert portion and the guide portion, and the insert portion, the base portion and the guide portion altogether form a hook-like to be able to move along the gutter.

It is preferred that the ring-shaped elastic body is equipped with a mount for attaching a fixing device, and the fixing device comprises a base portion to be contacted by a gutter, a support portion extending from one end of the base portion and having a shape matched with an inner shape of the gutter, and a hold portion extending from the other end of the base portion and holding the mount, and the base portion, the support portion and the hold portion altogether form a hook-like shape to be detachably fixed on the rim.

The sixth aspect of the present invention is a method of mounting a tire-information transmitter on the tire/wheel assembly having a flexible tube according to the first aspect comprises; disposing a flexible tube equipped with a tire-information transmitter in the tire; filling a gas in the flexible tube; assembling the tire and the wheel; and filling a gas in the tire to provide a given inner pressure.

The seventh aspect of the present invention is a method of mounting a tire-information transmitter on the tire/wheel assembly having a narrow hanger according to the first aspect comprises; provisionally tacking a narrow hanger equipped with a tire-information transmitter to one or both of bead portion(s) of the tire, or suspending the hanger from the bead portion(s); engaging both of the bead portions with the rim base of the wheel; and filling a gas in the tire to fit the bead portion with the rim, thereby clipping the narrow hanger between the bead portion and the rim.

The eighth aspect of the present invention is a method of mounting a tire-information transmitter on the tire/wheel assembly having a bead seat ring according to the first aspect comprises; provisionally tacking a narrow hanger equipped with a tire-information transmitter to one or both of bead portion(s) of the tire, or suspending the hanger from the bead portion(s); engaging both of the bead portions with the rim base of the wheel; fixing the narrow hanger on a bead seat ring; and engaging the bead seat ring with the rim base.

The elastic body is not particularly limited as far as it can elastically expand its diameter at the time of being attached and can elastically contract its diameter to be fixed on the rim after being attached. The elastic body is preferably a rubber band for the first aspect, and a rubber ring such as an O-ring for the second aspect.

### BRIEF DESCRIPTION OF THE DRAWINGS

FIG. 1 is a sectional view of a tire/wheel assembly of the first embodiment according to the first aspect of the present invention;

FIG. 2 is a sectional view of another tire/wheel assembly of a first embodiment according to the first aspect of the present invention;

FIG. 3 is a sectional view of the tire showing a sequence of installing a tire-information transmitter;

FIG. 4 is a sectional view of the tire showing a sequence of installing a tire-information transmitter;

FIG. 5 is a sectional view of the tire showing a sequence of installing a tire-information transmitter;

FIG. 6 is a sectional view of the tire showing a sequence of installing a tire-information transmitter;

FIG. 7 is a sectional view of a wheel mounting a tire for a construction vehicle showing a flange configuration;

FIG. 8 is a sectional view of a tire/wheel assembly of the second embodiment of the present invention;

FIG. 9 is a sectional view of the tire showing a sequence of installing a tire-information transmitter;

FIG. 10 is a sectional view of the tire showing a sequence of installing a tire-information transmitter;

FIG. 11 is a sectional view of a tire/wheel assembly of the third embodiment of the present invention;

FIG. 12 is a perspective view of a narrow hanger;

FIG. 13 is a sectional view of the tire showing a sequence of installing a tire-information transmitter;

FIG. 14 is a sectional view of a tire/wheel assembly of the first modification example of the third embodiment according to the present invention;

FIG. 15 is a sectional view of the tire showing a sequence of installing a tire-information transmitter;

FIG. 16 is a sectional view of a tire/wheel assembly of the second modification example of the third embodiment according to the present invention;

FIG. 17 is a sectional view of the tire showing a sequence of installing a tire-information transmitter;

FIG. 18 is a sectional view of a tire/wheel assembly of the third modification example of the third embodiment according to the present invention;

FIG. 19 is a sectional view of the tire showing a sequence of installing a tire-information transmitter;

FIG. 20 is a sectional view of a tire/wheel assembly of the forth embodiment according to the first aspect of the present invention;

FIG. 21 is a sectional view of the tire showing a sequence of installing a tire-information transmitter;

FIG. 22 is a sectional view of the tire showing a sequence of installing a tire-information transmitter;

FIG. 23 is a sectional view of the tire showing a sequence of installing a tire-information transmitter;

FIG. 24 is a perspective view of a representative installation device according to the second aspect of the present invention;

FIG. 25 is a sectional view of the installation device taken at the plane B of FIG. 24;

FIG. 26 is a sectional view of the installation device taken at the plane C of FIG. 24;

FIG. 27 is a sectional view of another embodiment of the installation device shown in FIG. 24;

FIG. 28 is a sectional view of another installation device according to the present invention;

FIG. 29 is a sectional view of the installation device taken at the plane B of FIG. 28;

FIG. 30 is a sectional view of another embodiment of the installation device shown in FIG. 28;

FIG. 31 is a sectional view of a representative fixing device according to the third aspect of the present invention showing in a state where a mount is clipped and the fixing device is attached to a gutter;

FIG. 32 shows a sequent of installing an elastic body on a rim with a detachable flange on one side according to one embodiment;

FIG. 33 shows a sequent of installing an elastic body on a rim with a detachable flange on one side according to one embodiment;

FIG. 34 shows a sequent of installing an elastic body on a rim with a detachable flange on one side according to one embodiment;

FIG. 35 shows a sequent of installing an elastic body on a rim with a detachable flange on one side according to one embodiment;

FIG. 36 shows a sequent of installing an elastic body on a rim with a detachable flange on one side according to one embodiment;

FIG. 37 shows a sequent of installing an elastic body on a rim with a detachable flange on one side according to one embodiment;

FIG. 38 is a perspective view of another embodiment showing in a state where the mount is fixed on the rim with a detachable flange on one side;

FIG. 39 is an illustration of another embodiment showing an intermediate state where the elastic body is attaching to the rim with a detachable flange on one side;

FIG. 40 is a perspective view of a substantial part of the rim base of one embodiment showing in a state where a rubber ring, a mount and a tire-information transmitter have been equipped;

FIG. 41 is a perspective view of a substantial part of the rim base of another embodiment showing in a state where a rubber ring, a mount and a tire-information transmitter have been equipped; and

FIG. 42 is a perspective view of a substantial part of the rim base of another embodiment showing in a state where a rubber ring, a mount and a tire-information transmitter have been equipped.

### BEST MODE FOR CARRYING OUT THE INVENTION

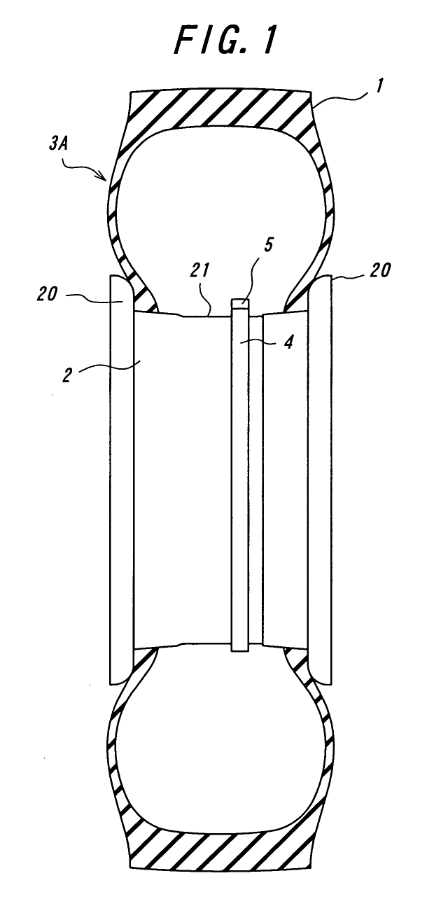

Hereinafter, through the first to the forth embodiments of a tire/wheel assembly for a construction vehicle according to the first aspect of the present invention will be described in detail with reference to the attached drawings. Referring now to FIGS. 1 to 6, the first embodiment is discussed. FIG. 1 is a partial sectional view of a tire/wheel assembly 3A of this embodiment. A tire 1 is mounted on a wheel 2 to form a tire/wheel assembly 3A, and a tire-information transmitter 5 is attached to a ring-shaped elastic body (a rubber band 4 in FIG. 1) which is placed along a periphery of a rim base 21 of a rim of the wheel 2. The tire-information transmitter 5 transmits various kinds of information regarding the tire to which the transmitter is attached and data measured by a temperature sensor and an inner pressure sensor embedded therein to outside the tire. When the tire-information transmitter 5 is a so-called transponder which transmits the information in response to an inquiry signal from a device outside the tire/wheel assembly 3A, it may utilize the inquiry signal as a power source. The tire-information transmitter 5 may also have an embedded battery as a power source and autonomously transmit the information.

The rubber band 4 is an elastic ring-shaped body capable of setting on the rim base 21 with a suitable tightening force, thereby securely fixing the rim base 21. In addition, the tire-information transmitter 5 is beforehand attached to the rubber band 4 as an integral part by means of a vulcanizing adhesion or a suitable joining means.

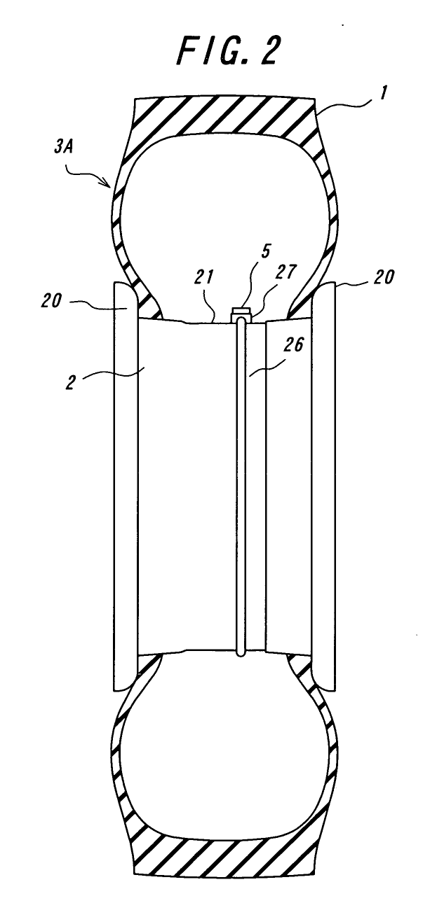

FIG. 2 is a partial sectional view of the tire/wheel assembly 3A of the first embodiment where the ring-shaped elastic body is a rubber ring 26. At least one mount 27 is provided on the rubber ring 26, and the tire-information transmitter 5 is fixed on the mount 27. The rubber ring 26 is capable of setting on the rim base 21 with a suitable tightening force, thereby securely fixing the rim base 21.

In this way, the tire-information transmitter 5 is securely fixed on the rim 20 via the rubber band 4 or the rubber ring 26. As a result, it can remarkably eliminate a possibility of damaging the tire due to various forced applied to the tire/wheel assembly equipped on, for example, a construction vehicle, as compared with the transmitter attached directly to the inner surface of the tire by means of adhesion. In addition, the position of the attached transmitter on the rim base 21 does not change, so that even when the tire is largely deformed inwardly by the above-mentioned force, the tire-information transmitter 5 is not affected by the deformation, and therefore does not lose its function. In the case where the tire-information transmitter 5 also has a function of detecting the temperature, the temperature in the cavity of the tire defined by the tire 1 and the wheel 2 can be accurately measured without any influence of the temperature of the wheel 2 as it does not directly contact the wheel 2.

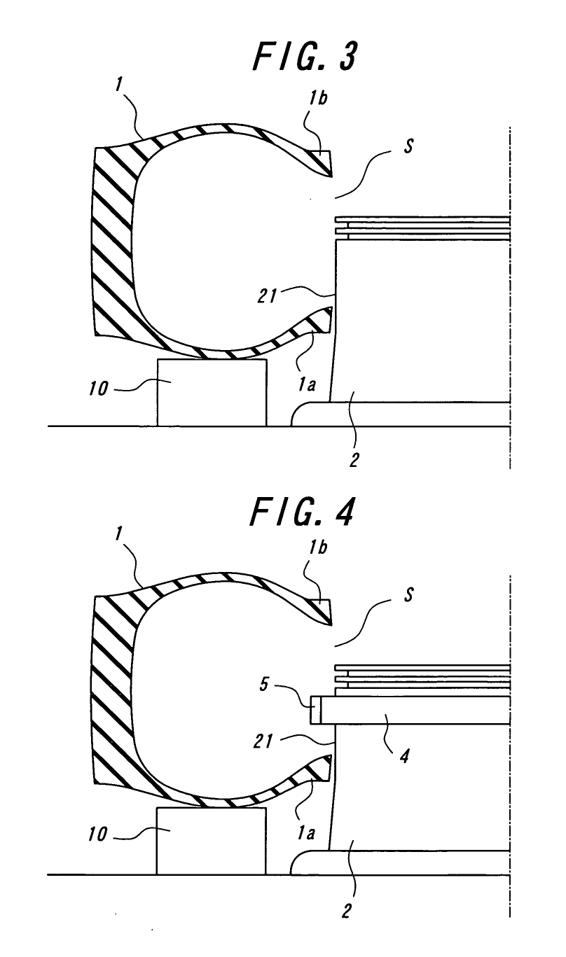

Next, discussed is a method of mounting the tire-information transmitter 5 in the tire via the rubber band 4 to obtain the tire/wheel assembly 3A shown in FIG. 1. FIGS. 3 to 6 are sectional views of the tire 1 showing a sequence of installing the tire-information transmitter 5. As shown in FIG. 3, when the tire 1 for a construction vehicle is equipped on the wheel 2, the tire 1 is lifted and held by, for example, placing it on a platform 10 at the time of putting one bead portion 1a of the tire 1 onto the rim base 21 of the wheel laid on the floor. In this state, as shown in FIG. 4, the rubber band 4 on which the tire-information transmitter 5 has already fixed is attached around the rim base 21 of the wheel 2 via the space S formed between the other base portion 1b and the wheel 2, and thereafter the bead portion 1b is put onto the rim base 21 of the wheel 2.

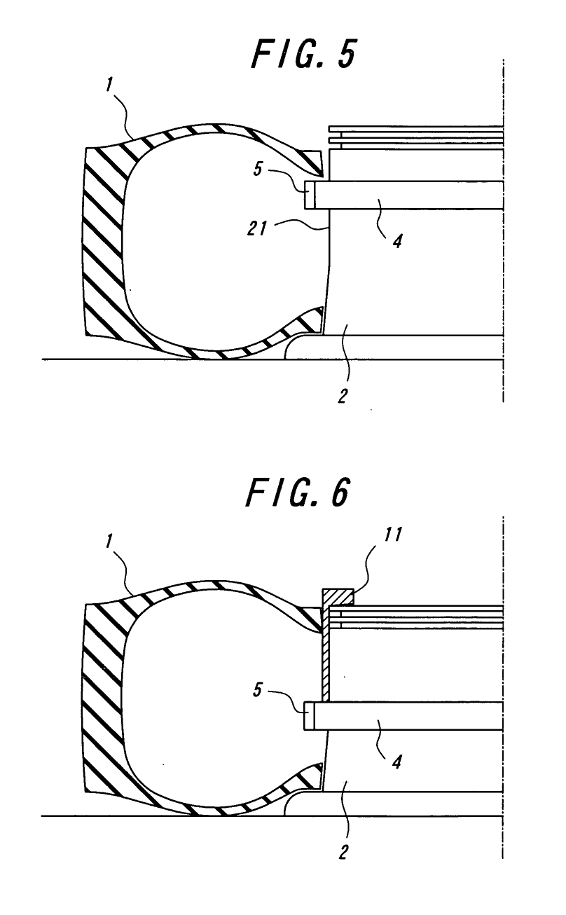

Then, the platform 10 on which the tire 1 is placed is removed and the tire 1 is laid on the floor, as shown in FIG. 5. In this state, in order to set the rubber band 4 on which the tire-information transmitter 5 is fixed at an appropriate position, i.e. approximately at the midpoint between the both beads, the position of the rubber band 4 is preferably adjusted by using a pushing jig 11, as shown in FIG. 6.

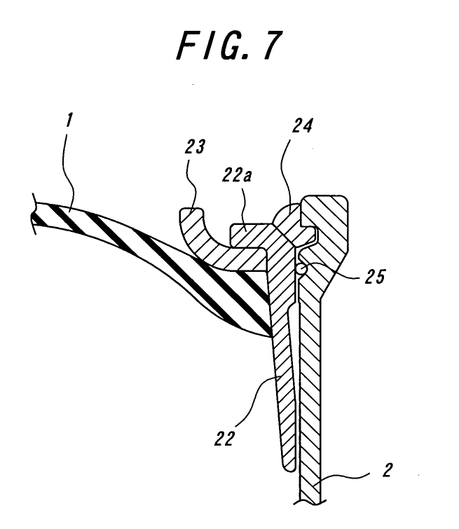

Further, a flange needs to be attached to an end of a tire-receiving side of the wheel 2 so that the tire 1 is equipped on the wheel 2. Consequently, the flange attached to the end of the tire-receiving side of the wheel is configured in such a manner that, as shown in FIG. 7, an O-ring packing 25 is first installed on the end of the tire-receiving side of wheel 2, and then a short cylindrical bead seat ring 22 in which a flange ring 23 is engaged with a bent portion 22a is inserted and a lock ring 24 is installed in the space between the wheel 2 and the bead seat ring 22, whereby the flange ring 23 can hold the tire 1.

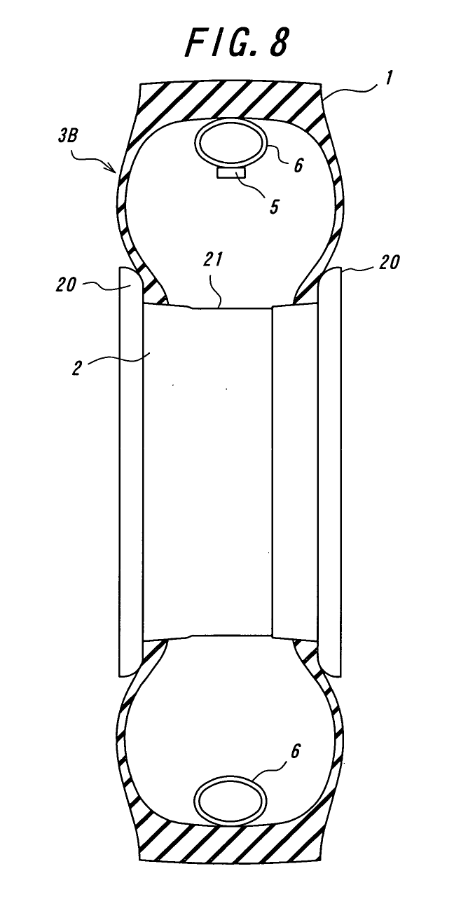

Next, a tire/wheel assembly 3B of the second embodiment is discussed with reference to FIGS. 8 to 10. In the tire/wheel assembly 3B, a flexible tube 6 equipped with a tire-information transmitter 5 is provided along the inner surface of the crown portion of a tire 1. When the flexible tube 6 is filled with gas, it is pressed against the inner surface of the crown due to the inner pressure of the tire 1 and is fixed at there. The flexible tube 6 filled with gas is served to intervene between the tire tread and the tire-information transmitter to prevent various input forces applied to the tire from transmitting to the tire-information transmitter 5. Accordingly, the tire-information transmitter is fixed at a position spaced from the inner wall of the tire 1 via the flexible tube 6 and thus is not subjected to the influence of various input forces applied to the tire/wheel assembly, so that the tire will not damaged nor the tire-information transmitter 5 will not lose its functions.

The tire-information transmitter 5 is beforehand attached to the flexible tube at the inner diameter side as an integral part by means of a vulcanizing adhesion or a suitable joining means.

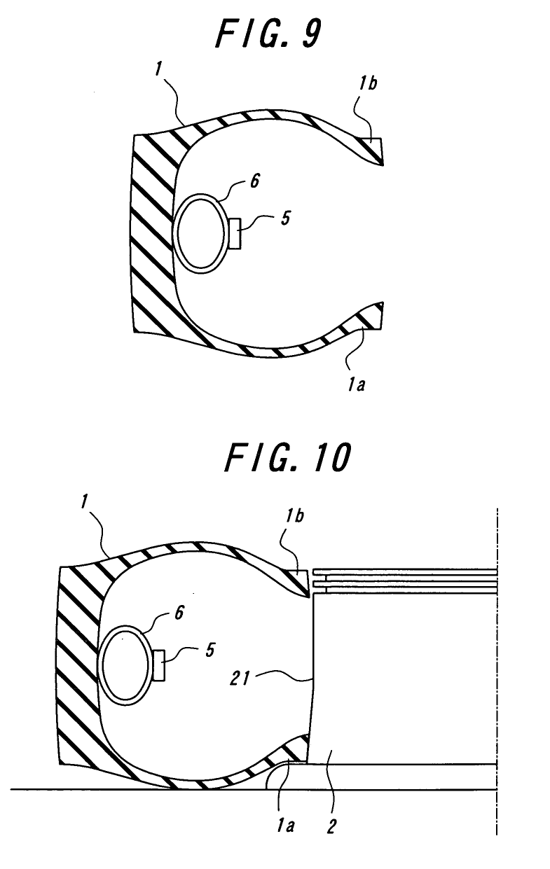

Next, discussed is a method of mounting the tire-information transmitter 5 in the tire via the flexible tube 6 to obtain the tire/wheel assembly 3B shown in FIG. 8. FIGS. 9 to 10 are sectional views of the tire showing a sequence of installing a tire-information transmitter 5 inside the tire. As shown in FIG. 9, the flexible tube 6 on which the tire-information transmitter 5 is beforehand fixed is disposed in the tire 1 and gas such as air or nitrogen is filled inside the flexible tube 6. Thereafter, an ordinal tire 1 is mounted on the wheel 2, as shown in FIG. 10. After the flange is attached, as shown in FIG. 7, when the tire 1 is filled with gas to provide an inner pressure, the flexible tube 6 on which the tire-information transmitter 5 is fixed can be provided along the inner surface of the crown portion of the tire 1. The inner pressure of the flexible tube 6 is preferably slightly higher than that of the tire in order to maintain its shape.

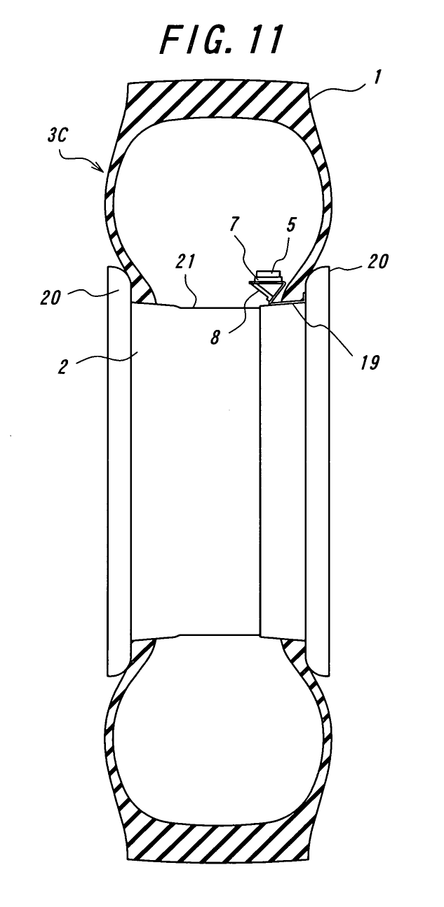

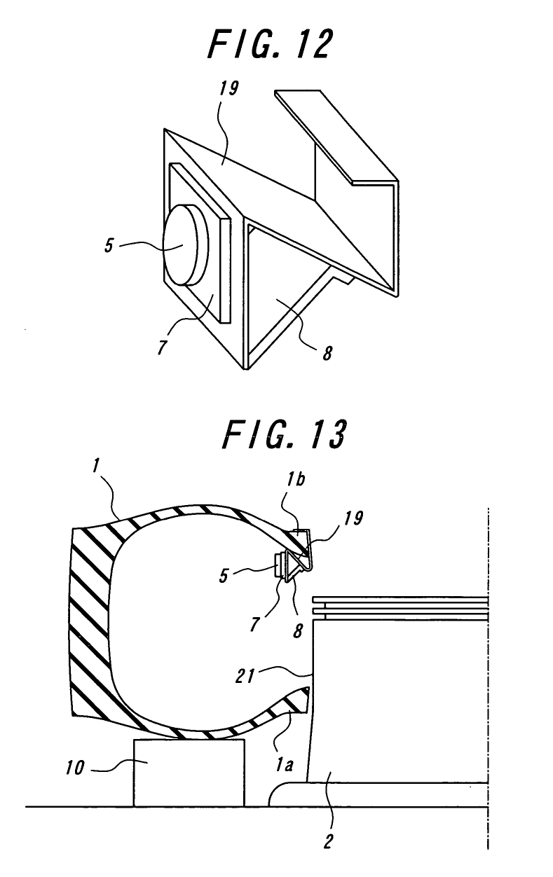

Next, a tire/wheel assembly 3C of the third embodiment according to the first aspect of the present invention is discussed with reference to FIGS. 11 to 19. FIG. 11 is a sectional view of the tire/wheel assembly 3C of this embodiment and FIG. 12 is a perspective view of a narrow hanger 19. On the tire/wheel assembly 3C constituted by mounting the tire 1 on the wheel 2, the narrow hanger 19 is fixed by clipping its base portion between the bead portion 1b of the tire 1 and the rim 20 of the wheel.

The tire-information transmitter 5 is attached at the tip of the narrow hanger 19 via an elastic base 7. The narrow hanger 19 is made of an elastic plate material such as a spring steel, and so configured that it extends like a horseshoe between the inner and outer surfaces of the bead portion 1b and is provisionally tacked on the bead portion under the action of the spring force clipping the inner and outer surfaces of the bead portion 1b. A stay 8 is attached to the narrow hanger 19 to suppress vibration of the tire-information transmitter 5 at the tip during the running. The width of the narrow hanger 19, i.e. the distance of the hanger 19 extending in the tire's width direction in a state of mounting on the tire/wheel assembly 3C may be minimized as far as the tire-information transmitter 5 can be securely fixed.

Next, discussed is a method of mounting the tire-information transmitter 5 in the tire via the narrow hanger 19 to obtain the tire/wheel assembly 3C shown in FIG. 11. FIGS. 9 to 10 are sectional views of the tire showing a sequence of installing a tire-information transmitter 5 inside the tire. FIG. 13 is a sectional view of the tire 1 before the tire-information transmitter 5 is installed in the tire. As shown in FIG. 13, when a tire 1 for a construction vehicle is mounted on the wheel 2, one bead portion 1a of the tire 1 is put onto the rim base 21 of the wheel 2 laid on the floor. Although the tire 1 is lifted and held by, for example, placing the tire 1 on a platform 10, the narrow hanger 19 is provisionally tacked on the other bead portion 1b under the action of the above-mentioned spring force prior to this.

After the state as shown in FIG. 13, the platform 10 is removed to lower the tire 1. The other bead portion 1b may also be easily put onto the rim base 21 since the narrow hanger 8 is placed radially outwardly from the outer periphery of the rim base 21 in the radial direction. Thereafter, an O-ring packing 25 is fitted on the end of the tire-receiving side of the wheel 2 in the same manner as is discussed in the first embodiment with reference to FIG. 7 and then a short cylindrical bead seat ring 22 in which a flange ring 23 is engaged with a bent portion 22a is inserted, and a lock ring 24 is installed in the space between the wheel 2 and the bead seat ring 22, whereby the flange ring 23 can hold the tire 1.

In this state, the narrow hanger 19 is sandwiched and held between the bead portion 1b and the bead seat ring 22, and the bead portion 1b and the flange ring 23, thereby being fixed. Once the narrow hanger is sandwiched by them and fixed, its spring force is not required for fixing the bead portion 1b any more. So the spring force may be at least sufficient for preventing a displacement of the narrow hanger 19 from the bead portion 1b until the bead portion 1b is fitted on the rim 20.

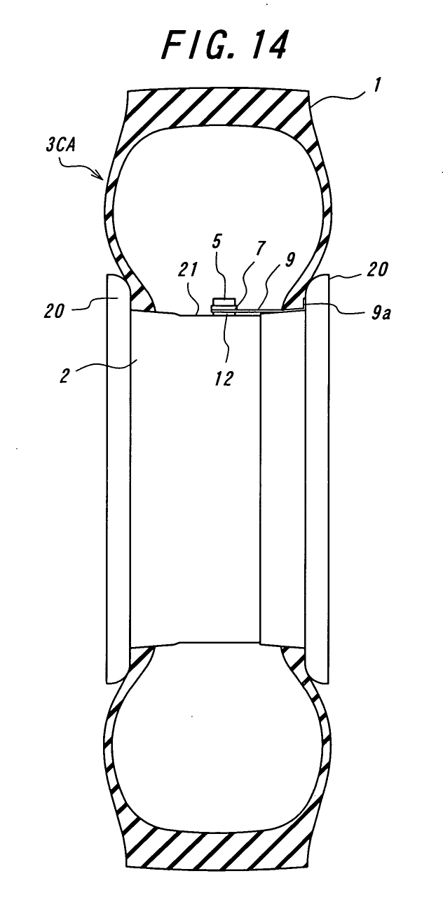

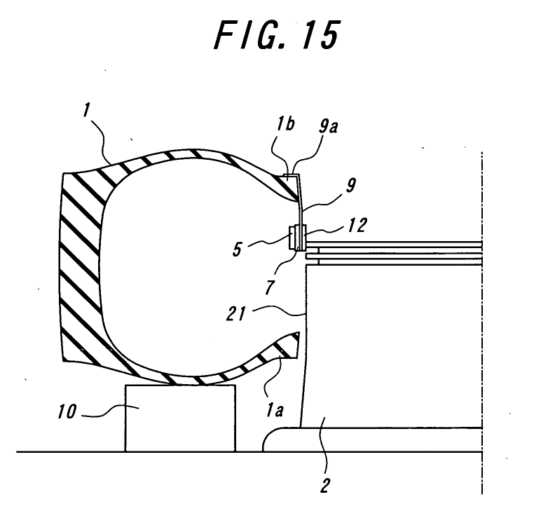

Hereinafter, some modification examples of the third embodiment are described. FIG. 14 is a sectional view of a tire/wheel assembly 3CA of the first modification example and FIG. 15 is a sectional view of the tire 1 showing a sequence of installing a tire-information transmitter 5 on the tire/wheel assembly 3CA of the first modification example. In the tire/wheel assembly 3CA, a narrow hanger 9, which takes the place of the narrow hanger 19 in the above-mentioned tire/wheel assembly 3C, is clipped and fixed between the bead portion 1b of the tire 1 and the rim 20. The tire-information transmitter 5 is attached at the tip of the narrow hanger 9 via an elastic base 7, and a spacer 12 is provided on the other side opposed to the side of which the tire-information transmitter 5 is attached at the tip to ensure a space between the narrow hanger 9 and a rim base 21 of the wheel. This configuration makes it possible to locate the tire-information transmitter 5 apart from both of the wheel 2 and the tire 1.

In the above-mentioned tire/wheel assembly 3C, the narrow hanger 19 made of a spring steel is provisionally tacked on the bead portion 1b by clipping the bead portion 1b from its outside and inside under the action of its spring force after the first bead portion 1a is mounted on the rim base 21 and before the second bead portion 1b mounted on the rim base 21. To the contrary, in the tire/wheel assembly 3CA of the first modification example, the narrow hanger 9 is suspended from the bead portion 1b by hooking a hook portion 9a, which is provided at the base end of the narrow hanger 9, on the outer surface of the bead portion 1b as viewed from the width direction.

When the other bead portion 1b is put onto the rim base 21, the narrow hanger 9 may be kept away from the rim base 21 by a spacer 12 attached at the tip of the narrow hanger 9. Thereafter, in the same manner as described for the above-mentioned tire/wheel assembly 3C, the rim 20 and the bead portion 1b clip the base end of the narrow hanger 9 to fix the narrow hanger 9 therebetween.

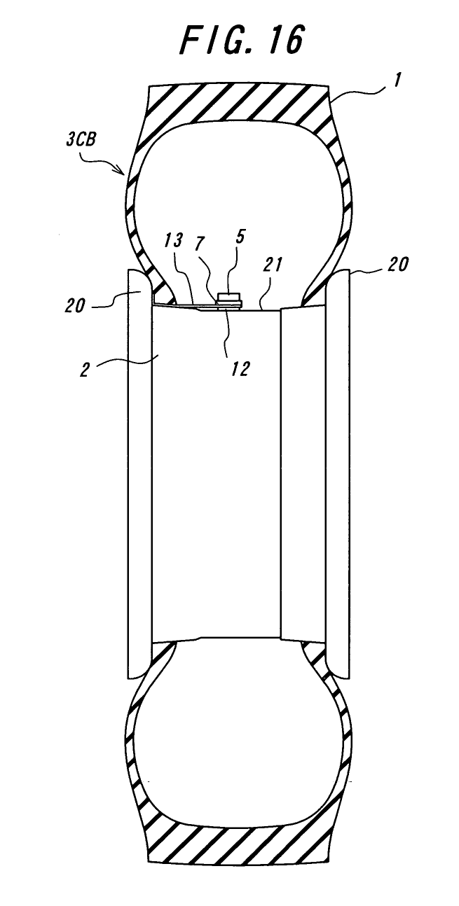

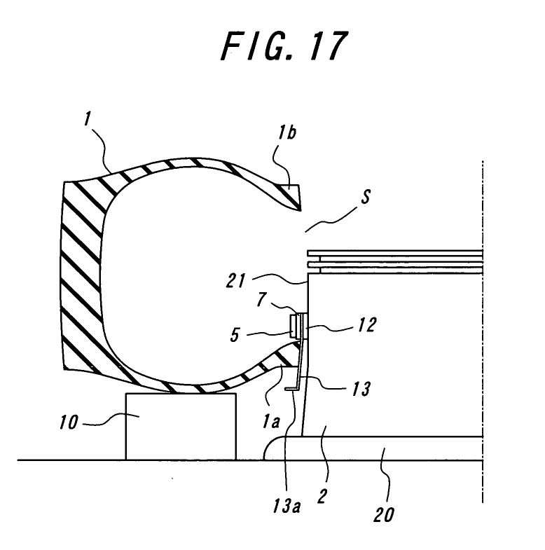

FIG. 16 is a sectional view of a tire/wheel assembly 3CB of the second modification example and FIG. 17 is a sectional view of a tire 1 of the second modification example showing a sequence of installing a tire-information transmitter 5 on the tire/wheel assembly 3CB. In the tire/wheel assembly 3CB, a narrow hanger 13 having a similar shape as that of the narrow hanger 9 in the tire/wheel assembly 3CA is sandwiched and fixed between one bead portion 1a, instead of the other bead portion 1b, and the rim 20. In addition, the tire-information transmitter 5 is attached at the tip of the narrow hanger 13 via an elastic body 7.

When the tire-information transmitter 5 is installed to the tire/wheel assembly 3CB, the tire-information transmitter 5 at the tip of the narrow hanger 13 is hooked on the inner surface of the bead portion 1a as viewed in the width direction prior to putting one bead portion 1a onto the rim base 21. Then, while the tire-information transmitter 5 is kept hooked on the inner surface of the bead portion 1a as viewed in width direction, the bead portion 1a of the tire 1 is put onto the rim base 21 and the tire 1 is laid on a platform 10, as shown in FIG. 17. Thereafter, the platform 10 is removed to lower the tire 1. When the bead portion 1a contacts the rim 20, the hook 13a provided at the base end of the narrow hanger 13 has already contact the rim 20, so that the tire-information transmitter is set apart from the bead portion 1a. The other bead portion 1b is then put onto the rim base 21, and both of the bead portions 1a, 1b are fitted to the rim 20 according to the above-mentioned procedure.

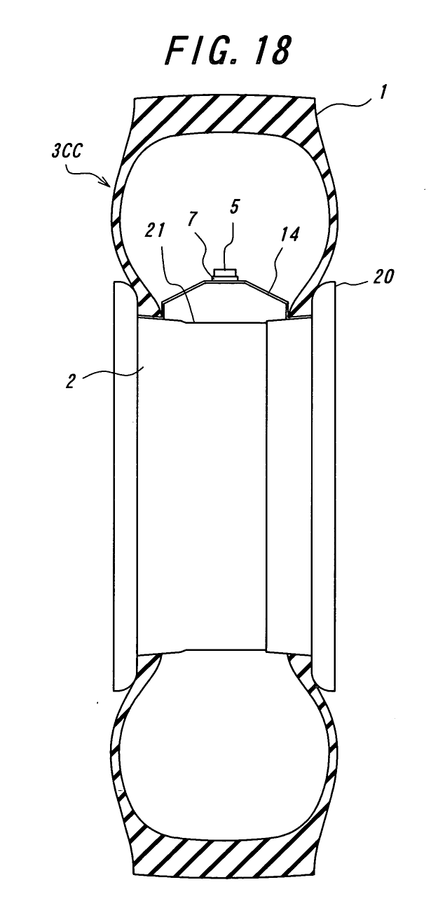

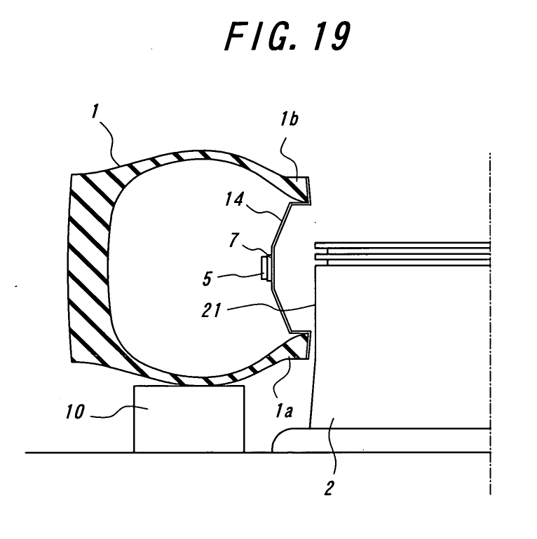

FIG. 18 is a sectional view of a tire/wheel assembly 3CC of the third modification example and FIG. 19 is a sectional view of the tire 1 showing a sequence of installing a tire-information transmitter 5 on the tire/wheel assembly 3CC of the third modification example. In the tire/wheel assembly 3CC, each end of a narrow hanger 14 is sandwiched and fixed between a respective bead portion 1a, 1b and the corresponding rim 20. The tire-information transmitter 5 is attached to a central portion of the narrow hanger spaced from the both ends via an elastic base 7.

In the installation of the tire-information transmitter 5, each end of the narrow hanger 14 made of a spring steel is provisionally tacked on the corresponding bead portions 1a and 1b, respectively, as to press the bead portions 1a and 1b outwardly as viewed from the width direction prior to putting the both bead portions 1a, 1b onto the rim base 21.

As shown in FIG. 19, while the both ends of the narrow hanger 14 are tacked on the bead portions 1a, 1b, the bead portions 1a and 1b of the tire 1 are put onto the rim base 21 and then the both bead portions 1a and 1b are fitted to the rim 20 according to the above-mentioned procedure, so that each end of the narrow hanger 14 may be sandwiched and fixed between the respective bead portion 1a, 1b and the corresponding rim 20. As shown in FIGS. 18 and 19, the both ends of the narrow hanger 14 may be terminated at the part corresponding to the bead seat face of the bead portions 1a, 1b, but the both ends may extend to the outer surface of the bead portions as viewed from the width direction. In the latter case, the narrow hanger 14 can be provisionally tacked on the bead portions 1a and 1b more securely.

In the third modification, the both ends of the narrow hanger 14 are sandwiched and fixed between the corresponding bead portion 1a, 1b and the corresponding rim 20, so that the tire-information transmitter 5 can be securely fixed on the tire/wheel assembly 3CC.

In the above-discussed tire/wheel assembly of the third embodiment including its modification example, the narrow hanger on which the tire-information transmitter 5 is installed is sandwiched and fixed between the bead portion of the tire and the rim. Therefore, the tire 1 and the tire-information transmitter 5 are not damaged and, if the tire-information transmitter 5 detects the temperature, it is not subjected to the influence of the temperature of the wheel as discussed above since its installation is easy and the tire-information transmitter is so placed as to space from both of the tire and wheel. Further, the tire-information transmitter 5 is attached to the narrow hanger via the elastic body 7, so that the tire-information transmitter 5 is prevented from damages due to vibrations and impacts.

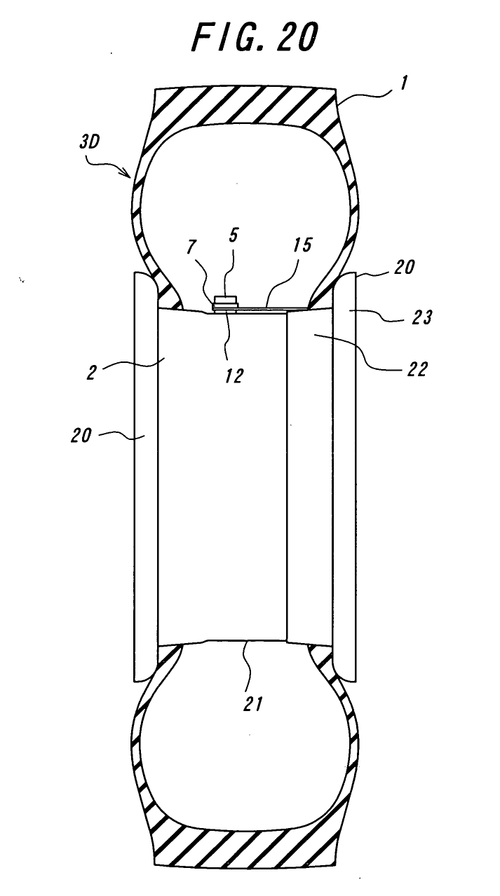

The forth embodiment of a tire/wheel assembly 3D according to the first aspect is now discussed with reference to FIGS. 20 to 23. FIG. 20 is a partial sectional view of a tire/wheel assembly 3D of this embodiment. The tire/wheel assembly 3D in which the tire 1 is mounted on the wheel 2 is provided with a narrow hanger 15 of which a tire-information transmitter 5 is attached via an elastic base 7 at the tip, and the base end of the narrow hanger 15 is fixed on a bead seat ring 22. A spacer 12 which ensures a space between a rim base 21 of the wheel 2 and the tire-information transmitter 5 is attached on a side of the narrow hanger 15 opposed to the side on which the tire-information transmitter 5 is attached,

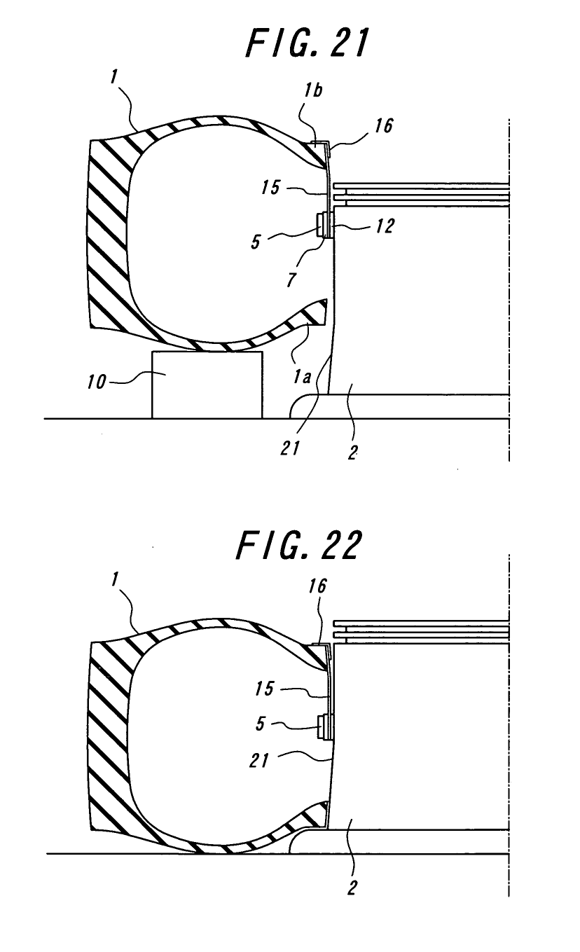

Next, discussed is a method of installing the tire-information transmitter 5 in the tire via the narrow hanger 15 to obtain the tire/wheel assembly 3D shown in FIG. 20. FIGS. 21 to 23 are sectional views of the tire 1 showing a sequence of installing the tire-information transmitter 5. Before putting the bead portion 1a onto the rim base 21, the base end of the narrow hanger 15 of which the tire-information transmitter 5 via the elastic base 7 and the spacer 12 are attached at the tip is provisionally tacked on the other bead portion 1b by an adhesive tape 16, thereby suspending from the bead portion 1b.

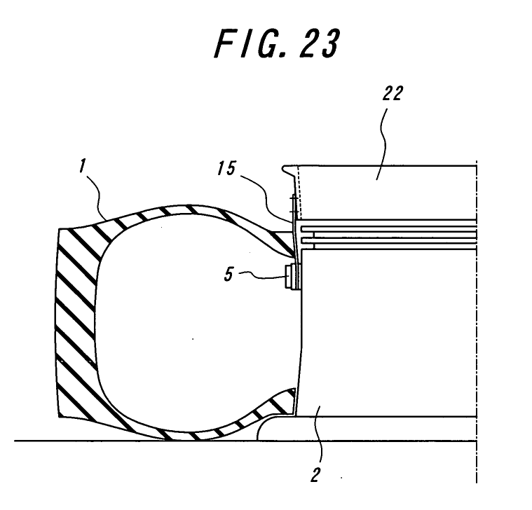

Then, as shown in FIG. 21, while the narrow hanger 15 is provisionally tacked on the other bead portion 1b, the bead portion 1a of the tire 1 is mounted on the rim base 21 and is temporary laid on the platform 10. Thereafter, the platform is removed to lower the tire 1 as shown in FIG. 22, whereby the other bead portion 1b is also put onto the rim base 21. Subsequently, as shown in FIG. 23, the bead seat ring 22 is placed above the rim base 21 and is kept hanging by, for example, a hoist. In this state, the adhesive tape 16 is peeled from the bead portion 1b and the base end of the narrow hanger is pulled upwardly to fix the base end of the narrow hanger 15 at a given place of the bead seat ring 22. Not-shown fastening means such as a screw may be used for such a fixing. The bead seat ring 22 and other parts are assembled with the wheel 2 according to the above-mentioned procedure with reference to FIG. 7, thereby completing the installation of the tire 1 on the wheel 2.

In this forth embodiment of the tire/wheel assembly 3D, the narrow hanger on which the tire-information transmitter 5 is installed is securely fixed on the bead seat ring 22 by means of a screw or the like, and the tire-information transmitter 5 is placed to be spaced from both of the tire and wheel. Therefore, the tire 1 and the tire-information transmitter 5 are not damaged and, if the tire-information transmitter 5 detects the temperature, it is not subjected to the influence of the temperature of the wheel.

In the above, although a tire/wheel assembly for a construction vehicle is described by way of example, the first aspect of the present invention is also applicable for, of course, tire/wheel assemblies for a passenger vehicle, truck and bus.

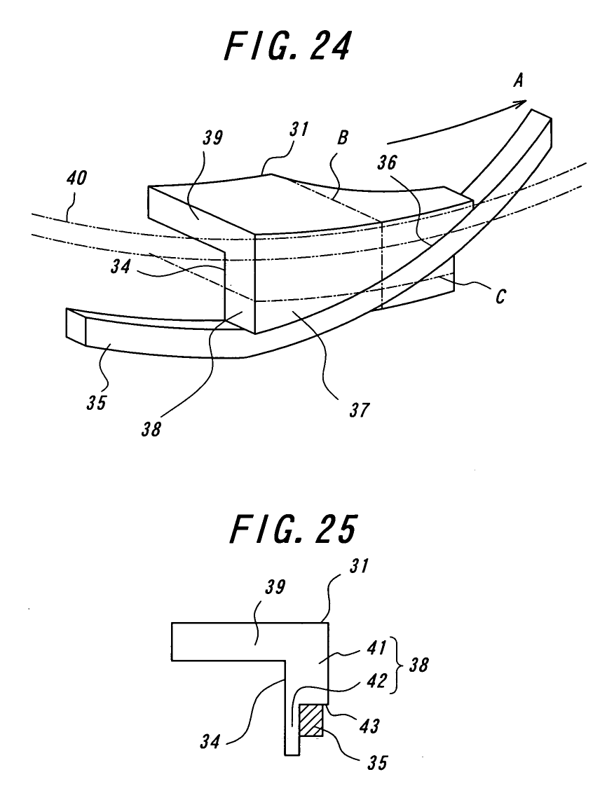

Next, an installation device according to the second aspect is discussed. FIG. 24 is a perspective view of a representative installation device according to the second aspect.

The installation device 31 shown in FIG. 24 has a base portion 39 to be contacted by a gutter 40 of a wheel which has a detachable flange on one side and which is in a state that the detachable flange has been removed. The installation device 31 also has a guide portion 38 having an outer surface 37 provided with a guide means 36 which slantly contacts a ring-shaped elastic body, e.g. a ring-shaped rubber band 35 in FIG. 24, equipped with a tire-information transmitter. The installing device 31 is so configured that the base portion 39 and the guide portion 38 make an L-shape and the installation device 31 may move along the gutter 40.

As the installation device is configured in L-shape, the installation device may easily engage with the gutter 40 by inserting the installation device 31 with holding the base portion 39 to match the guide portion 38 with the gutter 40 of the rim base. Further, as the rubber band 35 is attached to the guide portion 38, the rubber band 35 elastically expands and its diameter becomes larger than the diameter of the rim base. Even if the rubber band 35 is about to elastically contract, the diameter is maintained in the expanded state due to the state of the rubber band 35 being placed on the outer surface of the guide portion. In this state, when the installation device 31 moves in the direction shown by the arrow A in FIG. 24, the rubber band 35 is pressed down along the guide means 36. As a result, the rubber band 35 is sequentially dropped on the outer periphery of the rim base.

In this way, using the installation device 31 makes it easy to install the rubber band 35 on the rim base, thereby significantly improving the workability.

FIG. 25 is a sectional view of the installation device 31 taken at the plane B of FIG. 24. As shown in FIG. 24, the guide portion 38 of the installation device 31 preferably has a flat portion 41 having relatively large outer surface height and a valley portion 42 having an outer surface height lower than that of the flat portion 41. In this case, a stepped sidewall 43 formed between the flat portion 41 and the valley portion 42 acts as a guide means. While the rubber band 35 is guided along the stepped sidewall 43, the rubber band 35 is restrained by the outer surface 38 of the guide portion 38 contacting the rubber band 35. Therefore, even if the rubber band 35 is about to elastically contract, a disengagement of the rubber band 35 from the installation device 31 can be prevented. From the viewpoint of securely preventing the disengagement of the rubber band 35, the height of the stepped sidewall 43 is preferably larger than the thickness of the rubber band 35.

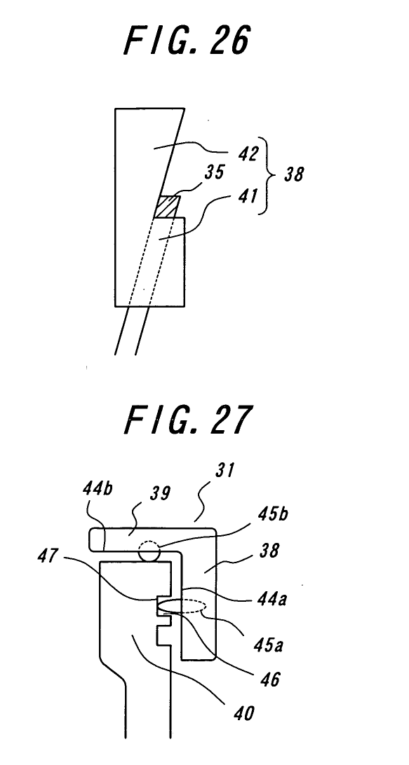

FIG. 26 is a sectional view of the installation device 31 taken at the plane C of FIG. 24. As shown in FIG. 26, the installation device 31 is preferably so configured that the outer surface height of a valley portion 42 gradually decreases along the direction in which the rubber band 35 is dropped, because such a configuration may further facilitate the dropping of the rubber band 35 to the rim base.

FIG. 27 is a sectional view of another embodiment of the installation device shown in FIG. 25. As shown in FIG. 27, each of contact surfaces 44a, 44b, which contacts the rim base, of a guide portion 38 and a base portion 39, respectively, of the installation device 31 preferably has at least one rolling element, e.g. each one rolling element 45a, 45b in FIG. 27. In the installation of the rubber band, the installation device 31 slides on the rim base, as mentioned above. As shown in FIG. 27, the rolling bodied 45a and 45b are provided on the contact surfaces 44a and 44b, respectively, so that the friction resistance of the installation device 31 during the sliding is reduced and the installation device may be moved with a smaller force, which facilitates the operation of installing the rubber band.

Although FIG. 27 shows an example in which the rolling element 45a is a rotating roller and the rolling element 45b is a rolling ball, the installation device 31 of the present invention is not limited to this combination but it can adopt any combinations capable of reducing the friction resistance during the running.

Further, from the viewpoint of preventing the installation device 31 from being raised by the contractive elastic force of the rubber band when the rubber band is installed on the rim base, the rolling element 45a provided on the contact surface 44a of the guide portion 38 is preferably positioned to be able to move along a groove 46 which goes around the entire periphery of the gutter 40, as shown in FIG. 27. In addition, from the view point of much effectively avoiding the raising of the installation device, the rolling element 45a is preferably a slender rotating roller and contacts a bottom 47 of the groove 46.

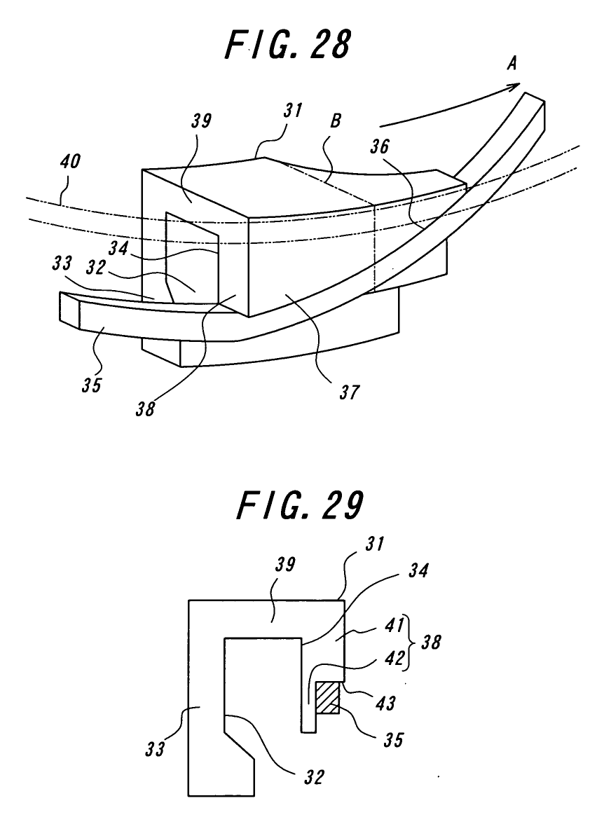

Furthermore, it is preferred that the installation device further has an insert portion 33 to be inserted from the gutter side into the inner surface side of the rim base of the wheel with the detachable flange being removed, the insert portion having an inner surface 32 facing the inner surface 34 of the guide portion 38 with a given distance therebetween, and the insert portion 33, the base portion 39 and the guide portion 38 altogether form a hook-like shape, as shown in FIGS. 28 and 20. The installation dived 31 is configured to be a hook-like shape and the insert portion 33 is engaged with the gutter 40, so that the raising of the installation device 31 can be more securely prevented even if the contractive elastic force of the rubber band 35 is larger.

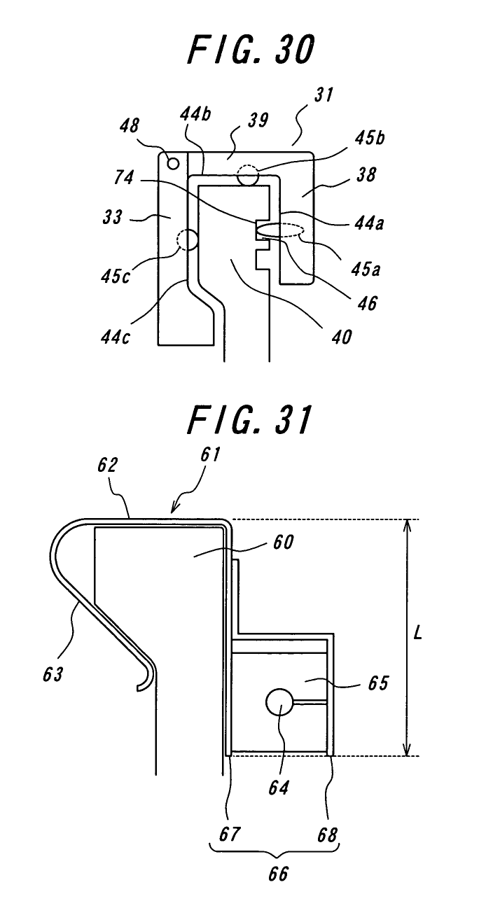

In addition, from the viewpoint of making it easy to attach the installation device 31 to the gutter 40, the insert portion 33 is connected with the base portion 39 by a hinge mechanism 48, as shown in FIG. 30. That is, when the installation device 31 is inserted, the hinge mechanism 48 is stretched to be in a state where the insert portion 33 and the base portion 39 are linearly continued. The installation may become much easier if the hinge mechanism 48 is folded to make the insert portion 33 into contacting the gutter 40 after the guide portion 38 is engaged with the gutter 40.

Moreover, the insert portion 30 preferably has at least one rolling element, e.g. one rolling element 45c in FIG. 30, on the surface 44 to be contacted by the rim base, because the friction resistance of the installing device during the movement is reduced and the installation device 31 may be moved by a smaller force, which facilitates the operation of installing the rubber band. Although FIG. 30 shows an example in which the rolling element 45c is a rolling ball, the rolling element 45c may be any suitable means, such as rotating roller, for reducing the friction resistance during the movement, as is the case with the rolling elements 45a, 45b.

Next a fixing device of the third aspect is discussed. FIG. 31 is a sectional view of a representative fixing device according to the third aspect.

The fixing device shown in FIG. 31 has a base portion 62 to be contacted by a gutter 60 of a wheel, said wheel comprising a rim having a detachable flange on one side and being in a state that the detachable flange has been removed, a support portion 63 extending from one end of the base portion 62 and having a shape matched with an inner shape of the gutter 60, and a hold portion 66 extending from the other end of the base portion 62 and holding a mount 65 provided on a ring-shaped elastic body, e.g. a rubber ring 64 in FIG. 31, equipped with a tire-information transmitter. The base portion 62, the support portion 63 and the hold portion 66 altogether form a hook-like shape to be detachably fixed on the rim.

As the fixing device 61 is configured in a hook-like shape, the fixing device 61 may catch the gutter 60 by simply inserting the fixing device 61 with holding the base portion 62 to match the support portion 63 with the gutter 60. Since screw fastening or the like is not required, the mount 65 is easily fixed at a given position on the rim. Further, since the fixing device is not fixed by a screw or the like, the fixing device 61 can be easily removed after the rubber ring 64 is dropped on the outer surface of the rim base by any means.

In this way, as shown in FIG. 40, the fixing device 61 facilitates the installation of the rubber ring 64 and the mount 65 equipped with the tire-information transmitter 53 on the rim base 69, which significantly improve the workability.

At least the support portion 63 of the fixing device 61 is preferably made of a spring steel and the support portion 63, together with the base portion 62 and/or the hold portion 66, is configured to clip the rim. With such a configuration, the fixing device much securely catches the gutter 60.

It is also preferred that the hold portion 66 has a body portion 67 and a clip portion 68 and the fixing device is so configured that the body portion 67 and the clip portion 68 altogether clip the mount 65 provided on the rubber ring 64. With such a configuration, the fixing device is easily and quickly attached to and detached from the mount 65, which further improve the workability.

It is also preferred that the length L of the hold portion 66 is approximately the same as the distance from the gutter 60 to the position at which the tire-information transmitter is fixed, as measured along the outer surface of the rim base. With such a configuration, the position of the tire-information transmitter does not need to be adjusted after the rubber ring 64 is installed on the rim base, which further improve the workability.

Next, discussed is a method of installing a ring-shaped elastic body equipped with a tire-information transmitter on a rim with a detachable flange on one side of a wheel.

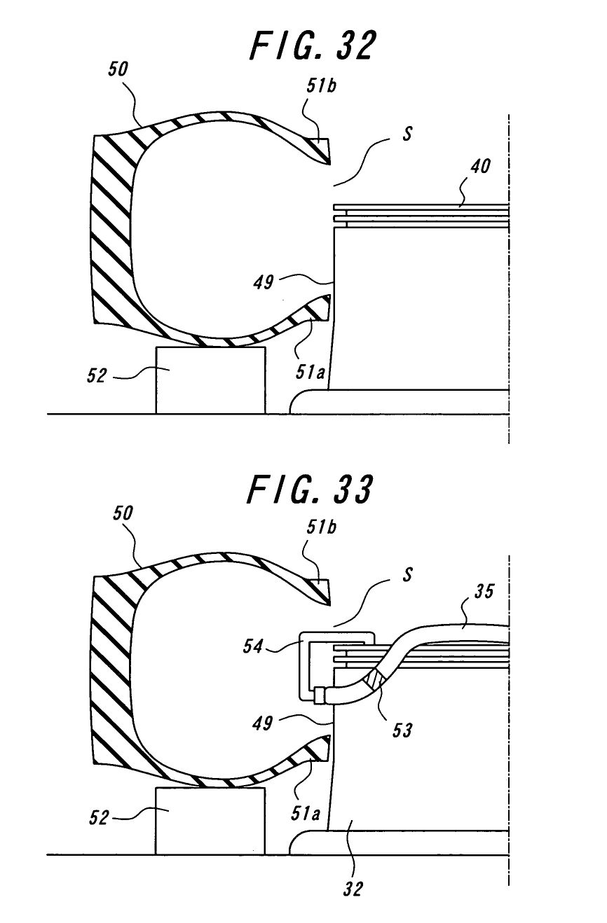

FIG. 32 shows a rim base 49 of a wheel in a state that a detachable flange has been removed. A gutter 40 is provided on the rim base 49 at the side to which the detachable flange has been installed. A bead portion 51a of a tire 50 is slipped from the gutter side and is put onto the rim base 49 laid on the floor. The tire 50 is lifted and held at the place where a space S exists between the other bead portion 51b and the gutter 40 of the rim by, for example, placing the tire 50 on the platform. In this state, as shown in FIG. 33, a part of a ring-shaped elastic body, e.g. a ring-shaped rubber band 35 in FIG. 33, equipped with an information transmitter 53 is wrapped around the rim base 49 via the space S existing between the other bead portion 51b and the gutter 40, and then the rubber band 45 is fixed by a fixing device 54 such as a C-clamp.

Next, discussed is a method of mounting the tire-information transmitter 5 in the tire via the rubber band 4 to obtain the tire/wheel assembly 3A shown in FIG. 1. FIGS. 3 to 6 are sectional views of the tire 1 showing a sequence of installing the tire-information transmitter 5. As shown in FIG. 3, when the tire 1 for a construction vehicle is equipped on the wheel 2, the tire 1 is lifted and held by, for example, placing it on a platform 10 at the stage of putting one bead portion 1a of the tire 1 onto the rim base 21 of the wheel laid on the floor. In this state, as shown in FIG. 4, the rubber band 4 on which the tire-information transmitter 5 has already fixed is attached around the rim base 21 of the wheel 2 via the space S formed between the other base portion 1b and the wheel 2, and thereafter the bead portion 1b is put onto the rim base 21 of the wheel 2.

In this connection, the rubber band 35 is configured to have a diameter slightly smaller than that of the rim base 49 so that it can be tightly fixed by the action of the elastic force of the rubber after it is mounted on the rim base 49. Further, the information transmitter 53 has been integrally mounted beforehand on the outer surface of the rubber band 35 by fixing means such as a vulcanizing adhesion.

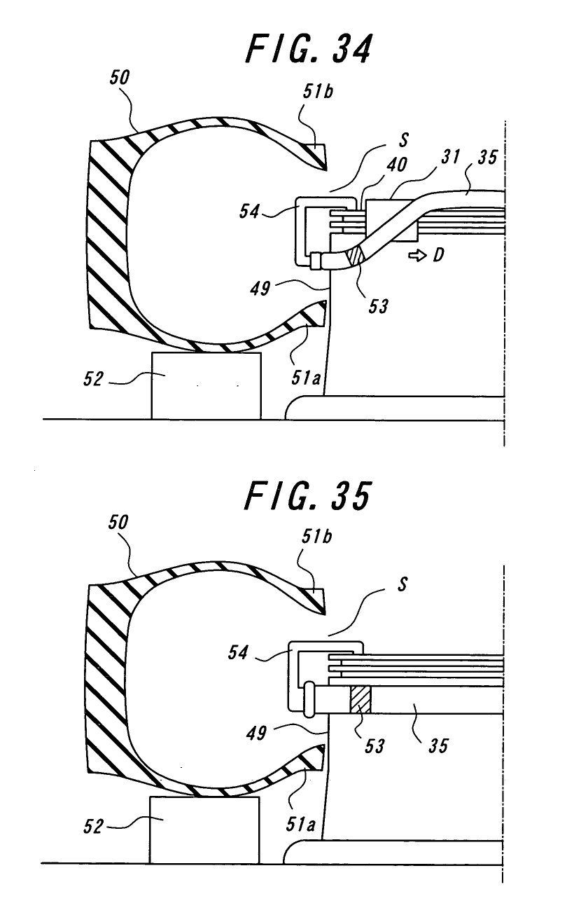

Then, as shown in FIG. 34, the installation device 31 which, for example, is mentioned above with reference to FIGS. 24 and 28 is attached to the gutter 40 and the rubber band 35 is attached to the guide means of the installation device 31. In this state, when the installation device 31 is displaced along the gutter 40 in the direction shown by the arrow D in FIG. 34, the entire rubber band 35 is stretched and is elastically deformed by the action of the above-mentioned installation device 31 as well as is pressed downwardly and is sequentially dropped on the rim base 49 by the action of the guide means. In this way, when the installation device 31 is moved along the rim base 49, the rubber band 35 is mounted on the rim base 49, as shown in FIG. 35.

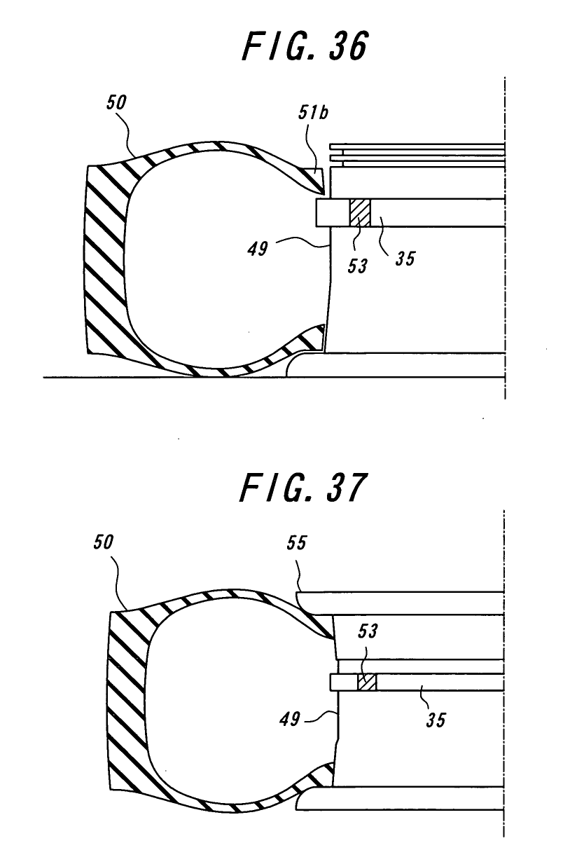

Thereafter, the fixing device 54 and the installation device 31 are removed and then the platform 52 supporting the tire 50 is removed. The entire tire 50 moves downwardly to put the bead portion 51b onto the rim base 49, as shown in FIG. 36. Finally, the detachable flange 55 which has been removed is attached to the gutter 40, so that the tire/wheel assembly as shown in FIG. 37 is formed.

Next, another embodiment of the fifth aspect of the present invention is discussed. One bead portion of a tire is put onto a rim base of a wheel in which a detachable flange has been removed. In this state, a part of a ring-shaped elastic body having a mount for attaching a fixing device is wrapped around the rim base via a space remaining between the other bead portion and a gutter and it is fixed by a fixing device such as one mentioned above with reference to FIG. 31.

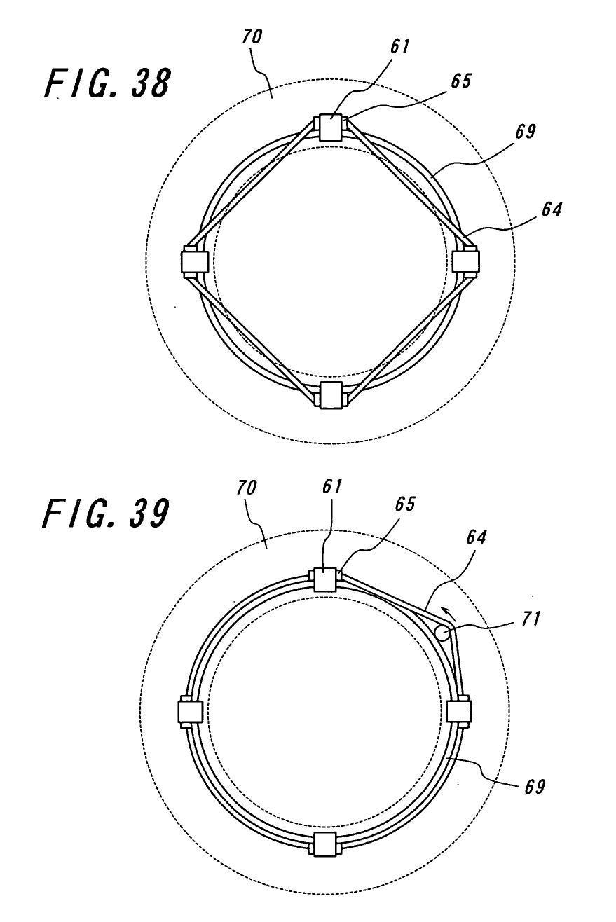

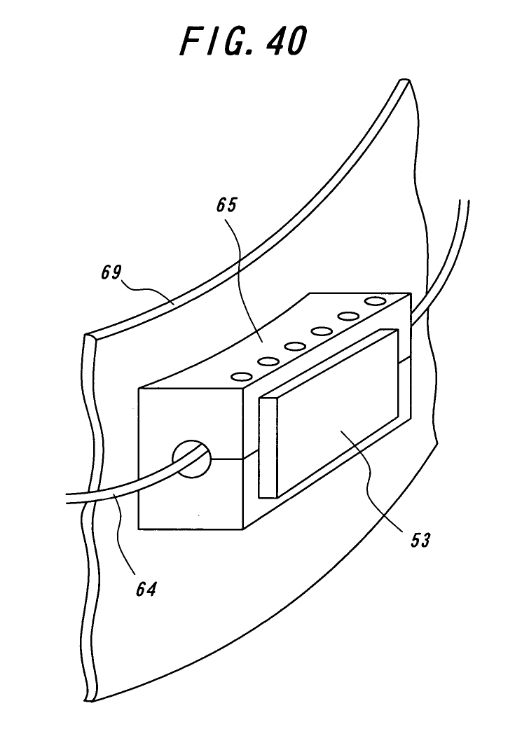

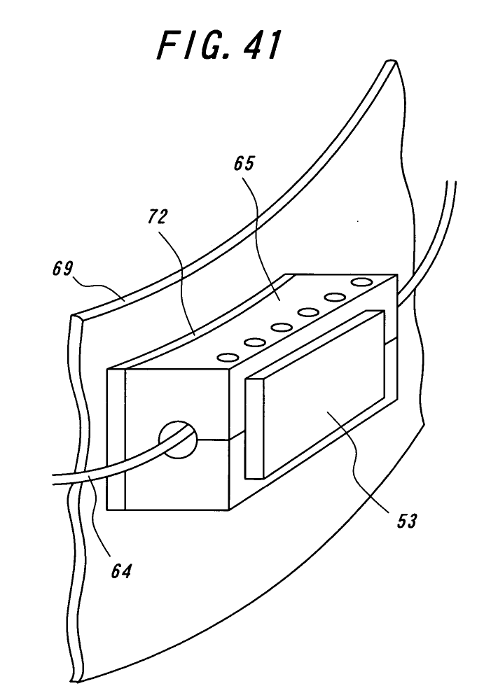

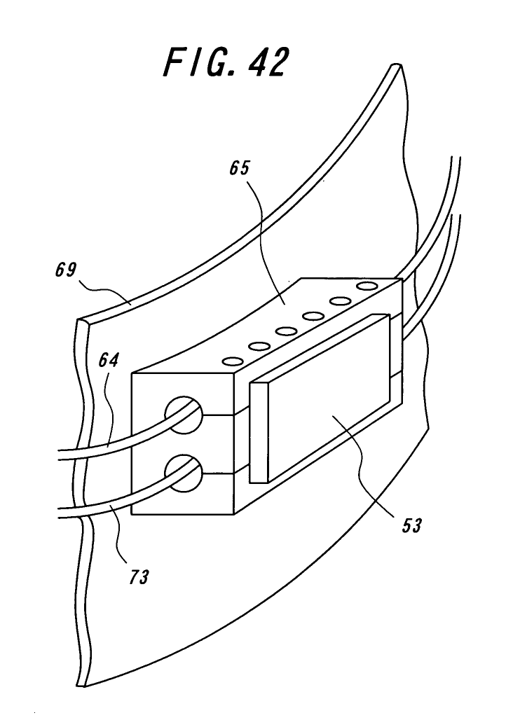

FIG. 38 shows a state where mounts 65 are fixed on a rim base 69 by four fixing devices 61, viewing from a side of a tire 70 which is drawn in dotted lines. At this stage, merely parts near the mounts 65 of the rubber ring 64 locate on the rim base 69 and the rest parts have not been mounted on the rim base 69. When a installation device 71 such as a bar is interposed between the elastic body 64 and the rim base 69 and is displaced along the gutter, as shown in FIG. 39, the rubber ring 64 is stretched and is elastically deformed by the action of the installation device to be sequentially dropped onto the rim base 69. The same operations are conducted between the fixing devices 61 and the entire rubber ring 64 is mounted on the rim base 69.

Thereafter, the fixing device 61 and the installation device 71 are removed and then the platform supporting the tire 70 is removed in the same manner as mentioned above. The entire tire 70 moves downwardly to put the other bead portion of the tire 70 on the rim base. Finally, the detachable flange which has been removed is attached to the gutter, so that the tire/wheel assembly is formed.

According to these methods, the elastic body my be mounted on the rim base only by displacing the installing device. Therefore, even in the case where the tire has a larger diameter, for example, in the case of a construction vehicle tire, the operation of installing the elastic body can be done by one person, which significantly improve the workability.

Although illustrative embodiments of the present invention have been described above, variations and modifications may be made without departing from the scope of the invention as defined by the appended claims. For example, the surfaces of the installation devices 3, 61 contacting the gutter may be coated with resin or the like, thereby decreasing the friction resistance between the contact surface and the gutter. Moreover, providing a magnet 72 on the inner surface of the mount 65, as shown in FIG. 71, may fix the mount 65 more securely. Furthermore, fixing the mount 65 on the rim base 69 by, in addition to the rubber ring 64, a wire ring having a diameter approximately the same as that of the rim may securely prevent the mount 65 from being lifted by the centrifugal force even if the tire rotates at a high speed.

### INDUSTRIAL APPLICABILITY

According to the present invention, it is possible to provide a tire/wheel assembly that ensure a proper function of a tire-information transmitter even in a severe use condition, installation and fixing devices for the tire-information transmitter which has a superior workability, and a method of mounting a tire-information transmitter in a simple manner.

1. A tire/wheel assembly comprising a tire, a wheel on which the tire is mounted, and a cavity portion defined by the tire and the wheel, wherein a tire-information transmitter is provided at a position spaced from both of the wheel and the tire in the cavity portion.

2. The tire/wheel assembly according to claim 1, wherein a ring-shaped elastic body equipped with said tire-information transmitter is provided along the periphery of a rim base of a rim of said wheel.

3. The tire/wheel assembly according to claim 2, wherein said ring-shaped elastic body is a rubber band.

4. The tire/wheel assembly according to claim 2, wherein said ring-shaped elastic body is a rubber ring.

5. The tire/wheel assembly according to claim 1, wherein a flexible tube equipped with said tire-information transmitter is provided along the inner surface of the crown portion of said tire.

6. The tire/wheel assembly according to claim 1, wherein a narrow hanger equipped with said tire-information transmitter is sandwiched and held between a bead portion of said tire and a rim of said wheel.

7. The tire/wheel assembly according to claim 1, wherein said wheel comprises a detachable bead seat ring contacting a bead portion to form a seat face, and a narrow hanger equipped with said tire-information transmitter is fixed on the bead seat ring.

8. The tire/wheel assembly according to claim 1, wherein said tire-information transmitter is a transponder.

9. The tire/wheel assembly according to claim 1, wherein an inner pressure sensor is built in the tire-information transmitter.

10. The tire/wheel assembly according to claim 1, wherein a temperature sensor is built in the tire-information transmitter.

11. An installation device comprising a base portion to be contacted by a gutter of a wheel, said wheel comprising a rim having a detachable flange on one side and being in a state that the detachable flange has been removed, and a guide portion having an outer surface provided with a guide means, said guide means being forcedly displaced while slantly contacting a ring-shaped elastic body equipped with a tire-information transmitter to drop the elastic body on an outer periphery of a rim base of the wheel, wherein said base and guide portions make an L-shape and said installation device moves along the gutter.

12. The installation device according to claim 11, wherein said guide means is a stepped sidewall slantly extending across the outer surface of the guide portion.

13. The installation device according to claim 1, wherein a portion of the outer surface of the guide portion with which said elastic body makes contact during its movement is so configured that its height at the outer surface gradually decreases along the direction in which the elastic body is dropped.

14. The installation device according to claim 11, wherein each of the base portion and the guide portion is provided with at least one rolling element at a surface to be contacted by the rim base.

15. The installation device according to claim 14, wherein the rolling element provided at the contact surface of the guide portion is so configured as to be able to move along a groove formed over a whole circumference.

16. The installation device according to claim 11, further comprising an insert portion to be inserted from the gutter side into the inner surface side of the rim base of the wheel in a state where the detachable flange has been removed, the insert portion having an inner surface facing the inner surface of the guide portion with a given distance therebetween, wherein the insert portion, the base portion and the guide portion altogether form a hook-like shape.

17. The installation device according to claim 16, wherein the insert portion is hinge-connected with the base portion.

18. The installation device according to claim 16, wherein the insert portion is provided with at least one rolling element at a surface to be contacted by the rim base.

19. A fixing device comprising a base portion to be contacted by a gutter of a wheel, said wheel comprising a rim having a detachable flange on one side and being in a state that the detachable flange has been removed, a support portion extending from one end of the base portion and having a shape matched with an inner shape of the gutter, and a hold portion extending from the other end of the base portion and holding a mount provided on a ring-shaped elastic body equipped with a tire-information transmitter, wherein the base portion, the support portion and the hold portion altogether form a hook-like shape to be detachably fixed on the rim.

20. The fixing device according to claim 19, wherein at least the support portion is made of a spring steel and the support portion, together with the base portion and/or the hold portion, is configured to clip the rim.

21. The fixing device according to claim 19, wherein the hold portion comprises a body portion extending along the outer surface of the rim base, and a clip portion branching and extending from the body portion, the clip portion being made of a spring steel, wherein the fixing device is so configured that the body and clip portions altogether clip the mount provided on the ring-shaped elastic body equipped with the tire-information transmitter.

22. The fixing device according to claim 19, wherein the length of the hold portion is approximately the same as the distance from the gutter to the position at which the tire-information transmitter is fixed as measured along the outer surface of the rim base.

23. A method of mounting a tire-information transmitter on the tire/wheel assembly according to claim 2, comprising;
putting one bead portion of the tire onto a periphery of a rim base of the wheel;
attaching a ring-shaped elastic body on the periphery of the rim base of the wheel via a space formed between the other bead portion of the tire and the wheel, the ring-shaped elastic body having been equipped with a tire-information transmitter beforehand; and
fitting both of the bead portions with the rim of the wheel.

24. A method of mounting a ring-shaped elastic body equipped with a tire-information transmitter on a rim of a wheel by means of an installation device, the wheel comprising a rim having a detachable flange on one side, and a guide portion having an outer surface provided with a guide, comprising;
provisionally putting one bead portion of the tire from a gutter side onto a rim base of the wheel in a state that the detachable flange has been removed while a space remains between the other bead portion and the gutter of the rim;
wrapping a part of said elastic body around the rim base via the space;
fixing the elastic body with a fixing device;
attaching a installation device to the gutter;
setting the elastic body to the installation device;
displacing the installation device along the gutter while elastically stretching the elastic body to mount the entire elastic body on the rim base;
removing the fixing and installation devices;
putting the other bead of the tire onto the rim base; and
attaching the removed detachable flange to the gutter to fabricate a tire/wheel assembly.

25. A method of mounting a tire-information transmitter on the tire/wheel assembly according to claim 5, comprising;
disposing a flexible tube equipped with a tire-information transmitter in the tire;
filling a gas in the flexible tube;
assembling the tire and the wheel; and
filling a gas in the tire to provide a given inner pressure.

26. A method of mounting a tire-information transmitter on the tire/wheel assembly according to claim 6, comprising;
provisionally tacking a narrow hanger equipped with a tire-information transmitter to one or both of bead portion(s) of the tire, or suspending the hanger from the bead portion(s);
engaging both of the bead portions with the rim base of the wheel; and
filling a gas in the tire to fit the bead portions with the rim, thereby sandwiching and holding the narrow hanger between the bead portion and the rim.

27. A method of mounting a tire-information transmitter on the tire/wheel assembly according to claim 7, comprising;
provisionally tacking a narrow hanger equipped with a tire-information transmitter to one or both of bead portion(s) of the tire, or suspending the hanger from the bead portion(s);
engaging both of the bead portions with the rim base of the wheel;
fixing the narrow hanger on a bead seat ring; and
engaging the bead seat ring with the rim base.
